(19) United States
(12) Patent Application Publication
(10) Pub. No.: US 2013/0186722 A1
(43) Pub. Date: Jul. 25, 2013

(54) DECELERATION DEVICE FOR WINDOW SHADE

(71) Applicant: Ju-Huai Chen, Ershui Township (TW)

(72) Inventor: Ju-Huai Chen, Ershui Township (TW)

(73) Assignee: Chicology, Inc., Ontario, CA (US)

(21) Appl. No.: 13/355,465

(22) Filed: Jan. 20, 2012

(51) Int. Cl. F16D 51/04

(52) U.S. Cl. 188/336

(57) ABSTRACT

A deceleration device for window shade includes a casing, and a deceleration mechanism movably fitted in the casing with a front end protruded from the casing. The casing can be mounted in a shade roller tube of any window shade that has already been provided with an automatic winding mechanism, and the deceleration mechanism can work with the automatic winding mechanism by gradually increasing the resistance to the winding of a shade fabric around the shade roller tube by the automatic winding mechanism, so as to prevent the shade fabric from being instantaneously lifted to adversely damage the window shade. And, since the deceleration device can be separately mounted to a window shade having an automatic winding mechanism for use, it provides good applicability.

### FIELD OF THE INVENTION

The present invention relates to a deceleration device for window shade, and more particularly to a deceleration device that provides good applicability and can be mounted in a shade roller tube of any window shade that has already been provided with an automatic winding mechanism, and can work with the automatic winding mechanism by gradually increasing the resistance to the winding of a shade fabric around the shade roller tube by the automatic winding mechanism, so as to prevent the shade fabric from being instantaneously lifted to adversely damage the window shade.

### BACKGROUND OF THE INVENTION

Conventionally, a window shade, such as a Roman shade, includes a traverse shade roller tube, a lifting unit, a shade fabric connected to a lower edge of the shade roller tube, and an automatic winding mechanism installed in the shade roller tube and connected to the shade fabric. With the above arrangements, the window shade can be automatically wound up around the shade roller tube.

Since the automatic winding mechanism is designed without being subjected to any resistance when it winds up the shade fabric around the shade roller tube, a relatively strong instantaneous winding force provided by the automatic winding mechanism would possibly form a high impact on the window shade to result in undesirable damage of the window shade. To overcome the aforesaid disadvantage, various deceleration mechanisms for window shade have been developed for preventing the damage caused by the upward instantaneous winding force. However, all the currently commercially available deceleration mechanisms for window shade are so designed that they are assembled to an automatic winding mechanism for use. In the case of a window shade that already includes an automatic winding mechanism but not a deceleration mechanism, the user has to discard the old window shade and replace it with a new one equipped with an automatic winding mechanism having a deceleration mechanism assembled thereto, in order to overcome the problem caused by the strong and instantaneous winding force. Under this circumstance, it is obviously an unnecessary waste to discard the still useful old window shade and the automatic winding mechanism thereon just because the conventional deceleration mechanism has limited applicability and can not be separately mounted on the shade roller tube for use with the existing automatic winding mechanism.

It is therefore desirable to develop a deceleration device that provides good applicability and can be used with any window shade, so as to protect the window shade against damage due to instantaneous lifting of the shade fabric thereof by the automatic winding mechanism.

In view of the drawbacks in the prior art, it is tried by the inventor to develop an improved deceleration device that has good applicability for use with any window shade to protect the same against damage.

### SUMMARY OF THE INVENTION

A primary object of the present invention is to provide a deceleration device for window shade, which provides good applicability and can be mounted in a shade roller tube of any window shade that has already been provided with an automatic winding mechanism, and work with the automatic winding mechanism by gradually increasing the resistance to the winding of a shade fabric around the shade roller tube by the automatic winding mechanism, so as to prevent the shade fabric from being instantaneously lifted to adversely damage the window shade.

To achieve the above and other objects, the deceleration device for window shade according to a preferred embodiment of the present invention includes a casing, and a deceleration mechanism movably fitted in the casing with a front end protruded from the casing.

In the preferred embodiment, the casing is formed of at least two covering members closed to one another, and the deceleration mechanism is movably received in between the covering members.

In the preferred embodiment, the deceleration mechanism includes a barrel movably received in the casing, a shaft fitted in the barrel, a screw extended through the barrel to connect to the shaft, an elastic element put around the shaft, and a stopper fitted around a rear end of the shaft to locate behind the elastic element and contacting with an inner surface of the casing.

In the preferred embodiment, the barrel includes a locating block formed at a front end thereof to forward protrude from the casing, and a pipe portion formed at a rear end thereof. The pipe portion is provided on an inner surface with two diametrically opposite guide slots corresponding to each other; and the shaft is provided on an outer surface at a front end thereof with two radially outward raised blocks for correspondingly and movably engaging with the two guide slots.

In the preferred embodiment, the shaft is tapered toward the rear end, around where the stopper is fitted.

In the preferred embodiment, the stopper is provided with a slit extending a full axial length thereof.

With the above arrangements, the deceleration device provides good applicability because the casing can be mounted in a shade roller tube of any window shade that has already been provided with an automatic winding mechanism and the deceleration mechanism can work with the automatic winding mechanism by gradually increasing the resistance to the winding of a shade fabric around the shade roller tube by the automatic winding mechanism, so as to prevent the shade fabric from being instantaneously lifted to adversely damage the window shade.

### BRIEF DESCRIPTION OF THE DRAWINGS

The structure and the technical means adopted by the present invention to achieve the above and other objects can be best understood by referring to the following detailed description of the preferred embodiments and the accompanying drawings, wherein

FIG. 1 is an assembled perspective view of a deceleration device for window shade according to a preferred embodiment of the present invention;

FIG. 2 is a partially exploded perspective view of FIG. 1;

FIG. 3 is a fully exploded perspective view of FIG. 1;

FIG. 4 is an assembled front perspective view of a deceleration mechanism for the deceleration device of the present invention;

FIG. 5 is a partially exploded rear view of FIG. 4; and

FIG. 6 shows the deceleration device for window shade according to the present invention in use.

### DETAILED DESCRIPTION OF THE PREFERRED EMBODIMENTS

The present invention will now be described with some preferred embodiments thereof and with reference to the accompanying drawings.

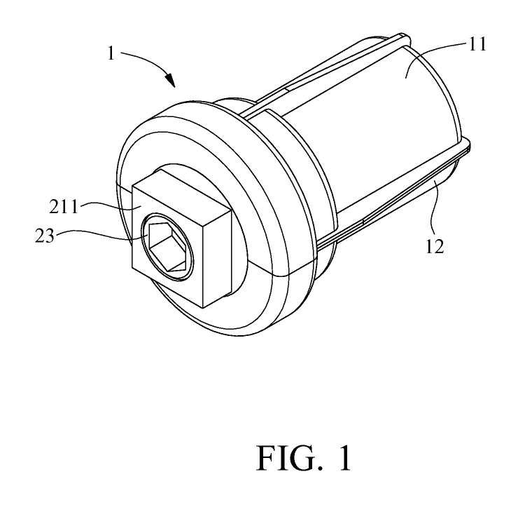

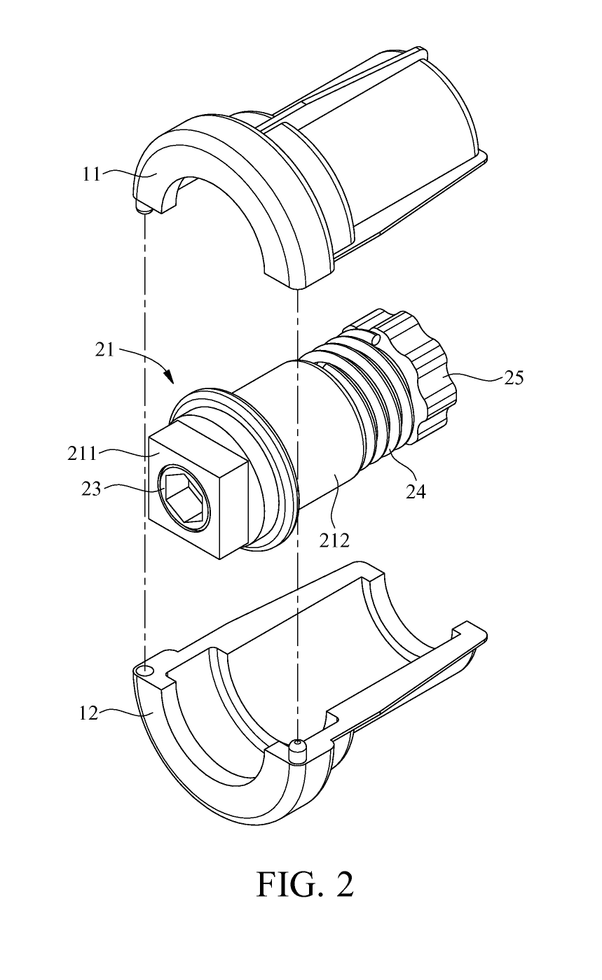

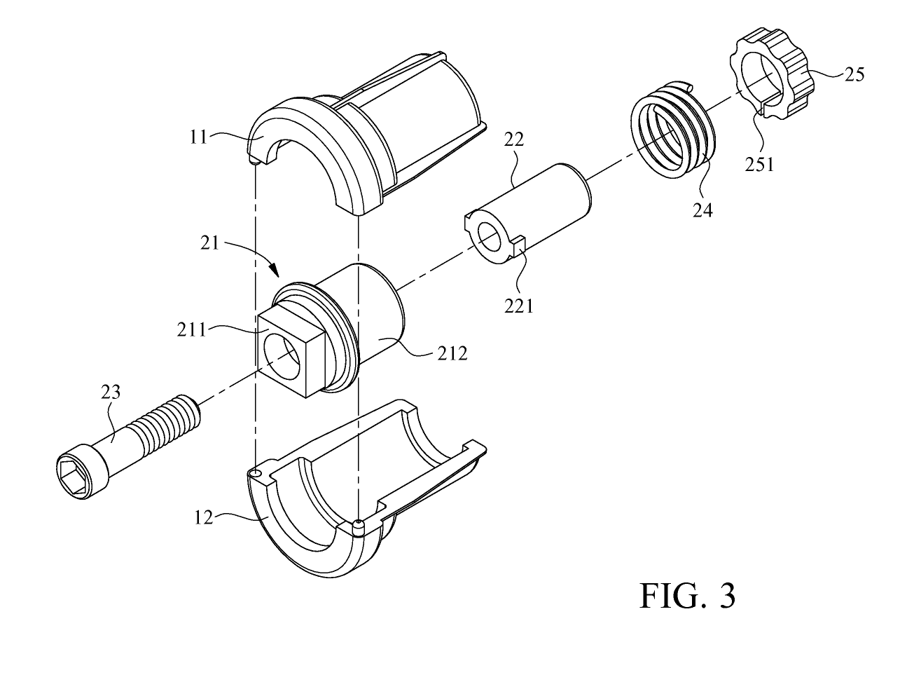

Please refer to FIGS. 1, 2 and 3 that are assembled, partially exploded and fully exploded perspective views, respectively, of a deceleration device for window shade according to a preferred embodiment of the present invention. As shown, the deceleration device for window shade includes a casing 1 and a deceleration mechanism 2.

The casing 1 is formed of at least two covering members closed to one another. In the illustrated preferred embodiment, there are two covering members 11, 12.

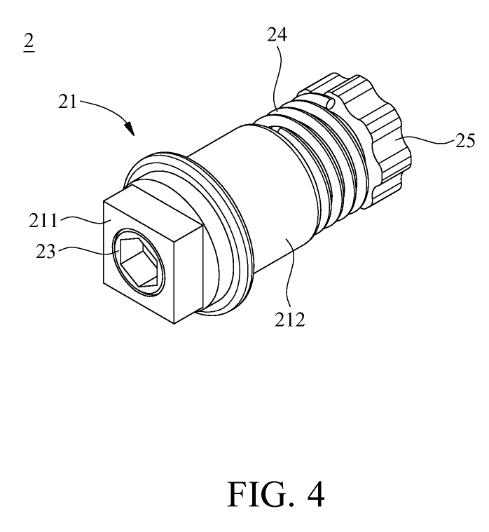

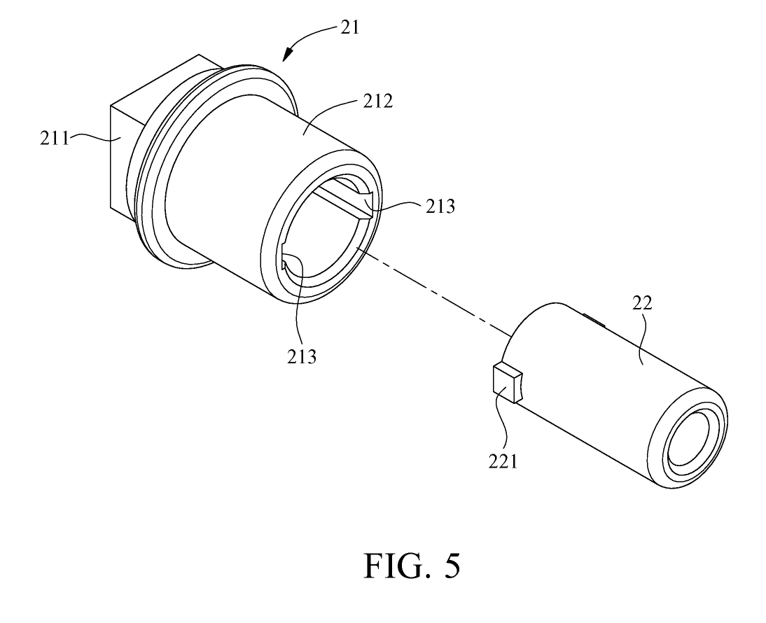

FIGS. 4 and 5 are assembled front and partially exploded rear perspective views, respectively, of the deceleration mechanism 2. Please refer to FIGS. 4 and 5 along with FIGS. 1 to 3. The deceleration mechanism 2 is movably fitted in between the two covering members 11, 12; and includes a barrel 21 movably received in the casing 1, a shaft 22 fitted in the barrel 21, a screw 23 extended through the barrel 21 to connect to the shaft 22, an elastic element 24 put around the shaft 22, and a stopper 25 fitted around a rear end of the shaft 22 to locate behind the elastic element 24 and contacting with an inner surface of the casing 1. The barrel 21 includes a locating block 211 formed at a front end thereof to forward protrude from the casing 1, and a pipe portion 212 formed at a rear end thereof. The pipe portion 212 is provided on an inner surface with two diametrically opposite guide slots 213 corresponding to each other. The shaft 22 is provided on an outer surface at a front end thereof with two radially outward raised blocks 221 for correspondingly and movably engaging with the two guide slots 213. Further, the outer surface of the shaft 22 is tapered toward the rear end thereof. And, the stopper 25 has a slit 251 extending a full axial length thereof, allowing a diameter of the stopper 25 to increase or decrease.

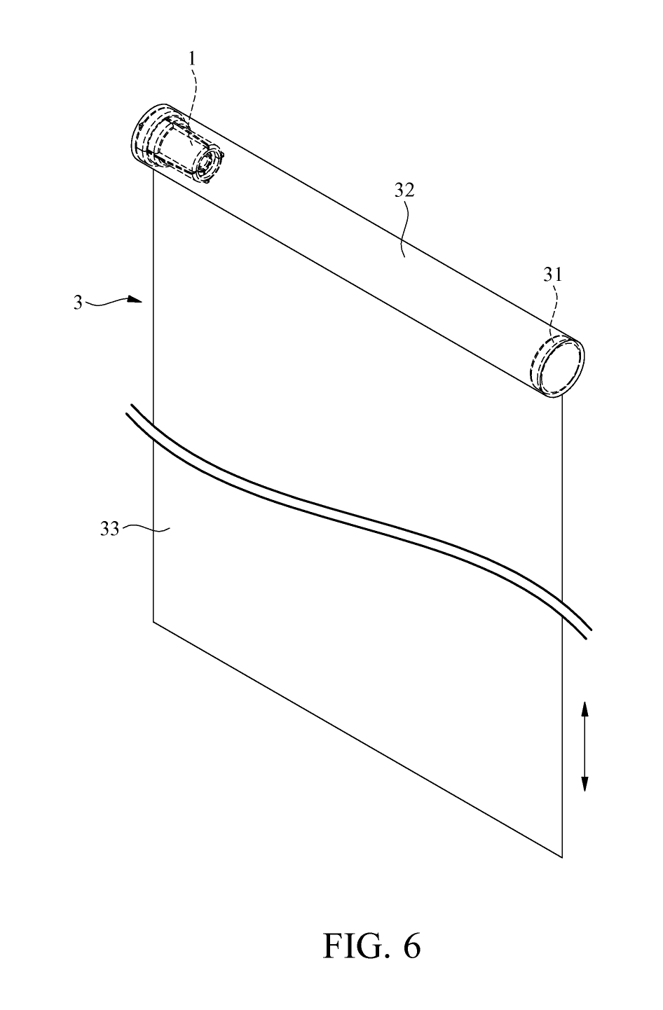

Please refer to FIG. 6 which shows the use of the deceleration device of the present invention on a window shade 3 equipped with an automatic winding mechanism 31. To mount the deceleration device of the present invention to the window shade 3, directly fit the casing 1 in an end of a traverse shade roller tube 32, which is connected to an upper end of a shade fabric 33 of the window shade 3, while the automatic winding mechanism 31 is installed in another opposite end of the shade roller tube 32. Since it is separate from the automatic winding mechanism 31, the deceleration device of the present invention provides good applicability and can be used with any window shade, even if the window shade already has an automatic winding mechanism. A user intending to lift the window shade 3 may utilize the automatic winding mechanism 31 to wind up the shade fabric 33 around the shade roller tube 32 and utilize a cooperative movement between the casing 1 and the deceleration mechanism 2 to gradually increase a resistance to the winding of the shade fabric 33 around the shade roller tube 32 at the same time. When the shade roller tube 32 is actuated by the automatic winding mechanism 31 to rotate, the shade roller tube 32 brings the casing 1, but not the deceleration mechanism 2, to rotate synchronously. However, the stopper 25 in contact with the inner surface of the casing 1 is brought by the casing 1 to rotate. With the slit 251 formed thereon, the stopper 25 can have a variable diameter and is allowed to reciprocate on along the rearward tapered shaft 22. When the stopper 25 moves closer to the comparatively large front end of the shaft 22, the stopper 25 is subjected to a radially outward push from the shaft 22 and therefore has an increased diameter to enter a frictional contact with the inner surface of the casing 1 and produce resistance. When the resistance exceeds a predetermined degree, the raised blocks 221 on the shaft 22 are brought to move along the guide slots 213 in the pipe portion 212 of the barrel 21 and thereby rotate the screw 23 in one direction, so that the shaft 22 is also brought to move toward one side and accordingly reduce it radially outward push against the stopper 25. With these arrangements, the deceleration mechanism 2 can gradually increase the resistance to the winding of the shade fabric 33 around the shade roller tube 32 by the automatic winding mechanism 31, preventing the shade fabric 33 from being instantaneously lifted to adversely damage the window shade 3.

The deceleration device for window shade according to the present invention is novel, improved and industrially practical for use. The present invention is novel and improved because the casing can be mounted in a shade roller tube of any window shade that already has an automatic winding mechanism, and the deceleration mechanism can work with the automatic winding mechanism by gradually increasing the resistance to the winding of the shade fabric around the shade roller tube by the automatic winding mechanism, so as to prevent the shade fabric from being instantaneously lifted to adversely damage the window shade. And, the present invention is industrially practical for use because the deceleration device can be used with a window shade having an automatic winding mechanism to thereby have good applicability, and products derived from the present invention would no doubt satisfy the current market demands.

The present invention has been described with a preferred embodiment thereof and it is understood that many changes and modifications in the described embodiment can be carried out without departing from the scope and the spirit of the invention that is intended to be limited only by the appended claims.

What is claimed is:

1. A deceleration device for window shade, comprising:
a casing; and
a deceleration mechanism movably fitted in the casing with a front end protruded from the casing.

2. The deceleration device as claimed in claim 1, wherein the casing is formed of at least two covering members closed to one another; and the deceleration mechanism being movably fitted in between the covering members.

3. The deceleration device as claimed in claim 2, wherein the deceleration mechanism includes a barrel movably received in the casing, a shaft fitted in the barrel, a screw extended through the barrel to connect to the shaft, an elastic element put around the shaft, and a stopper fitted around a rear end of the shaft to locate behind the elastic element and contacting with an inner surface of the casing.

4. The deceleration device as claimed in claim 3, wherein the barrel includes a locating block formed at a front end thereof to forward protrude from the casing, and a pipe portion formed at a rear end thereof; the pipe portion being provided on an inner surface with two diametrically opposite guide slots corresponding to each other; and the shaft being provided on an outer surface at a front end thereof with two radially outward raised blocks for correspondingly and movably engaging with the two guide slots.

5. The deceleration device as claimed in claim 4, wherein the shaft is tapered toward the rear end, around where the stopper is fitted.

6. The deceleration device as claimed in claim 5, wherein the stopper is provided with a slit extending a full axial length thereof.
